(19) United States
(12) Patent Application Publication
(10) Pub. No.: US 2023/0034811 A1
(43) Pub. Date: Feb. 2, 2023

(54) ELECTRIC OVEN

(71) Applicant: WINIADIMCHAE CO., LTD., Gwangsan-gu (KR)

(72) Inventors: Dong Won KIM, Hwaseong-si (KR); Byeong Geon PARK, Cheonan-si (KR); Jung Ho HWANG, Seongnam-si (KR); Min Young PARK, Cheonan-si (KR)

(21) Appl. No.: 17/508,184

(22) Filed: Oct. 22, 2021

(30) Foreign Application Priority Data
Jul. 30, 2021 (KR) 10-2021-0100961

(51) Int. Cl. F24C 7/08

(52) U.S. Cl. CPC F24C 7/087; F24C 7/085

(57) ABSTRACT

Provided is an electric oven in which, when a surface temperature of an opening or closing door reaches a set temperature while a body heats food with the opening or closing door closed, an alarm design visible with the naked eyes is displayed on a front surface of the opening or closing door by an alarm display portion so as to prevent burns or accidents caused by negligence of a user.

### CROSS-REFERENCE TO RELATED APPLICATION

This application claims priority to Korean Patent Application No. 2021-0100961, having a filing date of Jul. 30, 2021, the contents all of which are hereby incorporated by reference.

### FIELD OF TECHNOLOGY

The following relates to an electric oven and, more particularly, to an electric oven in which, when a surface temperature of an opening or closing door reaches a set temperature while a body heats food with the opening or closing door closed, an alarm design visible with the naked eyes is displayed on a front surface of the opening or closing door by an alarm display portion so as to prevent burns or accidents caused by negligence of a user.

### BACKGROUND

Generally, an electric oven is one of home appliances used for cooking or heating food in a kitchen at home, in which a heating portion emits heat using a heating heater and a pot or the like is placed on the heating portion so that the pot is heated by the emitted heat. Here, the heating portion for heating the pot emits high-temperature heat such that a case of suffering burns caused by user's negligence occurs sometimes.

In order to prevent this, a conventional electric oven is allowed to notify a user that a heating portion is currently emitting high-temperature heat through a lamp. That is, when a temperature of the heating portion is a reference temperature or higher, the lamp is turned on. The lamp is connected to a thermal switch so that the thermal switch is operated, and power is supplied when a temperature of the heating portion is the reference temperature or higher.

As described above, although the conventional electric oven employs a method of notifying with the lamp to prevent an accident such as burns, accidents with respect to the elderly or infirm or children who do not recognize the notification precisely occur sometimes.

Accordingly, it is necessary to remedy this.

As a related art thereof, there is Korean Patent Publication No. 10-2008-0019993 (titled Electric Oven, published on Mar. 5, 2008).

### SUMMARY

An aspect relates to an electric oven in which, when a surface temperature of an opening or closing door reaches a set temperature while a body heats food with the opening or closing door closed, an alarm design visible with the naked eyes is displayed on a front surface of the opening or closing door by an alarm display portion so as to prevent burns or accidents caused by negligence of a user.

According to an aspect, there is provided an electric oven including a body having one open side and configured to accommodate and heat food to be cooked, an opening or closing door hinge-coupled to the body and configured to cover an open part of the body to be opened or closed, and an alarm display portion attached to the opening or closing door and configured to display an alarm design when the body heats the food and thus a temperature of the opening or closing door reaches a set temperature.

The alarm display portion may change in color when a surface temperature of the opening or closing door reaches 40° C. and may restore to an original color from a changed color when the surface temperature of the opening or closing door reaches less than 40° C.

The alarm display portion may lose color and chroma and become transparent as the surface temperature of the opening or closing door becomes closer to 40° C.

The alarm display portion may be a thermo-sensitive film manufactured by mixing a film-printing solution with thermo-sensitive microcapsules.

### BRIEF DESCRIPTION

Some of the embodiments will be described in detail, with reference to the following figures, wherein like designations denote like members, wherein:

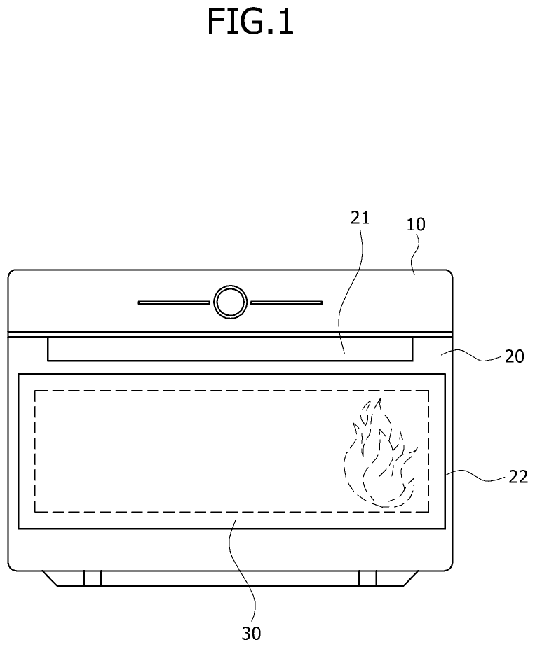

FIG. 1 is a view illustrating an electric oven according to one embodiment of the present invention;

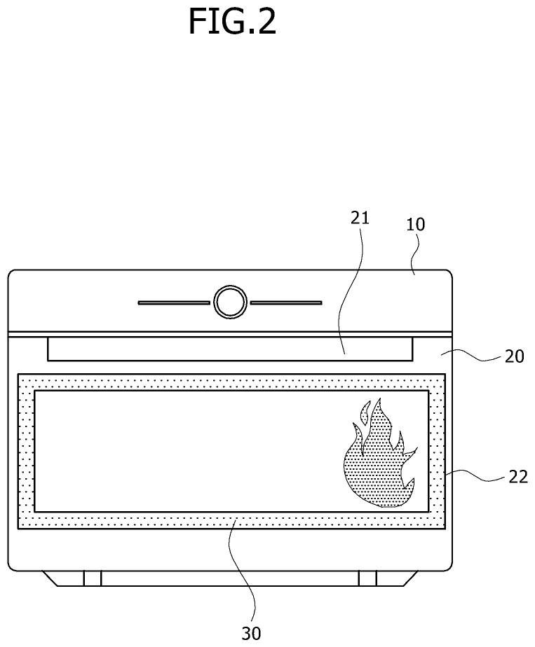

FIG. 2 is a view illustrating a state in which an opening or closing door reaches a set temperature and thus an alarm display portion changes in color in the electric oven according to one embodiment of the present invention; and

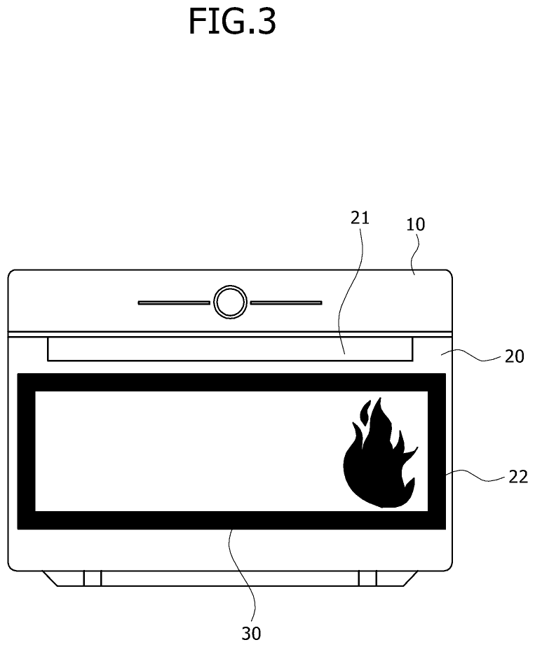

FIG. 3 is a view illustrating a state in which the alarm display portion has completely changed in color in the electric oven according to one embodiment of the present invention.

### DETAILED DESCRIPTION

Hereinafter, an electric oven according to one embodiment of the present invention will be described with reference to the attached drawings. During this process, thicknesses of lines, sizes of components, and the like which are shown in the drawings may be exaggerated for clarity and convenience of description.

Also, terms used herein are defined in consideration of the functions of the present disclosure and may be changed depending on a user, the intent of an operator, or a custom. Accordingly, the terms should be defined based on the following overall description of this specification.

FIG. 1 is a view illustrating an electric oven according to one embodiment of the present invention, FIG. 2 is a view illustrating a state in which an opening or closing door reaches a set temperature and thus an alarm display portion changes in color in the electric oven according to one embodiment of the present invention, and FIG. 3 is a view illustrating a state in which the alarm display portion has completely changed in color in the electric oven according to one embodiment of the present invention.

As shown in FIGS. 1 to 3, the electric oven according to one embodiment of the present invention includes a body 10, an opening or closing door 20, and an alarm display portion 30.

The body 10 includes a cooking chamber with one open side so as to accommodate and heat food to be cooked.

The body 10 not only performs a function of providing a space in which the opening or closing door 20 is installed to be opened or closed but also performs a function of providing a space in which food is heated while the opening or closing door 20 is closed.

Here, although not shown in the drawings, a heater is installed in the cooking chamber of the body 10 and a convection chamber having a certain space and including a convection heater and a fan therein is formed in the rear of the cooking chamber. That is, when the body configured as described above is operated, heat generated by the heater and the convection heater is supplied to an inside of the cooking chamber and thus food placed in the cooking chamber is heated by the heat.

Also, the opening or closing door 20 is hinge-connected to the body 10 and covers an open part of the body 10 to be opened or closed. The opening or closing door 20 guides food to be inserted into or taken out of the body 10 and prevents heat in the cooking chamber from being discharged outward when the body 10 heats accommodated food to be cooked.

Here, a handle portion 21 is formed on the opening or closing door 20 to be gripped by a user to open or close the opening or closing door 20. That is, the opening or closing door 20 pivots to be opened when the user pulls the handle 21 toward the user and pivots to close the cooking chamber when the handle 21 is pushed toward the body 10.

Also, the opening or closing door 20 may include a transparent window 22 to allow a cooked state of food heated in the cooking chamber to be seen with the naked eye while the opening or closing door 20 is closed.

Meanwhile, the alarm display portion 30 is attached to the opening or closing door 20 and displays an alarm design when the body 10 heats food and thus a temperature of the opening or closing door 20 reaches a set temperature.

Here, the alarm display portion 30 is formed of a thermo-sensitive film which changes in color when a surface temperature of the opening or closing door 20 reaches 40° C. or higher and restores to original color inform a changed color when the surface temperature of the opening or closing door 20 becomes less than 40° C. Here, the thermo-sensitive film is manufactured by mixing a film-printing solution with thermo-sensitive microcapsules.

However, the alarm display portion 30 is not limited to a particular color and design and may include a variety of colors and designs and may become transparent as color and chroma disappear when the temperature surface becomes close to 40° C.

That is, when heat generated in the cooking chamber, while food inserted into the body 10 is heated with the opening or closing door 20 closed, is transferred to the opening or closing door 20 and thus the surface temperature of the opening or closing door 20 increases and reaches 40° C., the alarm display portion 30 reacts to the heat and changes in color with the color and chroma becoming more vibrant and then completely changes in color to display a design notifying a danger of a high temperature as soon as the surface temperature reaches 45° C. Here, the alarm display portion 30 maintains a state in which color has completely changed with respect to a surface temperature of the opening or closing door 20 of 45° C. or higher.

On the other hand, when the body 10 stops heating food with the opening or closing door 20 closed so that the surface temperature of the opening or closing door 20 decreases from 45° C. to 40° C., the color and chroma gradually fade to change colors so that the design notifying the danger of high temperature disappears and becomes transparent and a transparent state is maintained from the moment the surface temperature reaches less than 40° C.

Therefore, according to embodiments of the present invention, since the design notifying the danger of high temperature is displayed on the opening or closing door 20 by the alarm display portion 30 when the food accommodated in the body 10 is heated, the user may recognize the surface temperature of the opening or closing door 20 while manipulating the opening or closing door 20 to be opened to withdraw the food from the body 10 so as to prevent burns or an accident caused by negligence.

Also, according to embodiments of the present invention, since the design notifying the danger of high temperature on the opening or closing door 20 disappears to be transparent when heating of the food accommodated in the body 10 is stopped, a view of the transparent window 22 provided in the opening or closing door 20 may be prevented from being blocked and overall aesthetics of the opening or closing door 20 may be prevented from being degraded.

According to embodiments of the present invention, since an electric oven has a structure in which, when a surface temperature of an opening or closing door reaches a set temperature while a body heats food with the opening or closing door closed, an alarm design visible with the naked eyes is displayed on a front surface of the opening or closing door by an alarm display portion, an effect of preventing burns or accidents caused by negligence of a user may be provided.

Although the embodiments of the present invention have been described with reference to the drawings, the embodiments are merely examples, and it should be understood by one of ordinary skill in the art that a variety of modifications and equivalents thereof may be made therefrom.

Accordingly, the technical scope of the present invention should be determined by the following claims.

What is claimed is:

1. An electric oven comprising:
a body having one open side and configured to accommodate and heat food to be cooked;
an opening or closing door hinge-coupled to the body and configured to cover an open part of the body to be opened or closed; and
an alarm display portion attached to the opening or closing door and configured to display an alarm design when the body heats the food and thus a temperature of the opening or closing door reaches a set temperature.

2. The electric oven of claim 1, wherein the alarm display portion changes in color when a surface temperature of the opening or closing door reaches 40° C. and restores to an original color from a changed color when the surface temperature of the opening or closing door reaches less than 40° C.

3. The electric oven of claim 2, wherein the alarm display portion loses color and chroma and becomes transparent as the surface temperature of the opening or closing door becomes closer to 40° C.

4. The electric oven of claim 1, wherein the alarm display portion is a thermo-sensitive film manufactured by mixing a film-printing solution with thermo-sensitive microcapsules.
